(19) United States
(12) Patent Application Publication
(10) Pub. No.: US 2025/0190762 A1
(43) Pub. Date: Jun. 12, 2025

(54) SYNTHETIC TRAINING DATA FOR GENERATIVE MODELS

(71) Applicant: Google LLC, Mountain View, CA (US)

(72) Inventors: Aliaksei Severyn, Zurich (CH); Alizée Pace, Zurich (CH); Eric Malmi, Zurich (CH); Sebastian Krause, Zurich (CH); Jonathan Mallinson, Zurich (CH)

(21) Appl. No.: 18/534,206

(22) Filed: Dec. 8, 2023

(51) Int. Cl. G06N 3/0455; G06N 3/092

(52) U.S. Cl. CPC G06N 3/0455; G06N 3/092

(57) ABSTRACT

Implementations are directed to generating synthetic labeled/preference data by extracting preference pairs from sets of N outputs to a given unlabeled input to a generative model. A plurality of generative outputs are generated by a generative model from a set of input data. A reward model is used to determine a plurality of reward values for the plurality of generative outputs. Based on the reward values, a pair of generative outputs from the plurality of generative outputs is selected for inclusion in a training example. The pair of outputs include a positive training example and a negative training example, where the reward values indicate that the positive training example is preferred over the negative training example. The process can be repeated for a plurality of sets of input data to generate a plurality of training examples for inclusion in a training dataset, which can be used to update reward model(s).

### BACKGROUND

Various generative models have been proposed that can be used to process image content, audio content, natural language (NL) content and/or other input(s), to generate output that reflects generative content that is responsive to the input(s). As one example, stable diffusion models have been developed that can be used to process NL content and/or other input(s), to generate visual output that reflects NL content and/or other content that is responsive to the input(s). As another example, large language models (LLM(s)) have been developed that can be used to process NL content and/or other input(s), to generate LLM output that reflects NL content and/or other content that is responsive to the input(s). However, current utilizations of generative models suffer from one or more drawbacks.

As one example, generative models often require alignment with human preferences in order to learn to generate meaningful and/or useful outputs. One such method of aligning generative models is reinforcement learning from human feedback (RLHF), which uses human preference data to learn a reward model for use in reinforcement learning. The success of RLHF in generative model alignment is strongly dependent on the quality of an underlying reward model. A critical aspect of this paradigm is thus to accurately model human preferences, which involves the costly and time-consuming process of collecting feedback data to train the reward model. The quality of reward models, in turn, is determined by several factors, including the quantity of human labeled data (which often exhibits a high level of noise), the distribution of responses evaluated, and the accuracy of preference labels.

### SUMMARY

Implementations disclosed herein are directed to at least generating synthetic labeled/preference data by extracting preference pairs from sets of N outputs to a given unlabeled input to a generative model. A plurality of generative outputs are generated by a generative model from a set of input data. A reward model is used to determine a plurality of reward values for the plurality of generative outputs. Based on the reward values, a pair of generative outputs from the plurality of generative outputs is selected for inclusion in a training example. The pair of outputs comprises a positive training example and a negative training example, where the reward values indicate that the positive training example is preferred over the negative training example. The process may be repeated for a plurality of sets of input data to generate a plurality of training examples for inclusion in a training dataset. A training dataset including such training examples can be used to update the reward model or a further reward model. This form of self-training effectively augments any initial labeled/preference dataset with high-quality on-policy data/preferences.

In these and other manners, significant improvements in reward modeling performance can be obtained, which in turn results in improved generative models when trained using the updated reward model. The systems, method and apparatus described herein provide a scalable approach to augmenting reward model training through the generation of high-quality (e.g., low noise), on-policy synthetic labeled/preference data. This approach leverages the capabilities of generative models to produce a semi-supervised training framework.

In some implementations, the generative model can be an image generation model, an audio generation model, or a large language model (LLM).

In some implementations, an LLM can include at least hundreds of millions of parameters. In some of those implementations, the LLM includes at least billions of parameters, such as one hundred billion or more parameters. In some additional or alternative implementations, an LLM is a sequence-to-sequence model, is Transformer-based, and/or can include an encoder and/or a decoder. One non-limiting example of an LLM is GOOGLE'S Pathways Language Model (PaLM). Another non-limiting example of an LLM is GOOGLE'S Language Model for Dialogue Applications (LaMDA). However, and as noted, it should be noted that the LLMs described herein are one example of generative machine learning models are not intended to be limiting.

The preceding is presented as an overview of only some implementations disclosed herein. These and other implementations are disclosed in additional detail herein.

### BRIEF DESCRIPTION OF THE DRAWINGS

FIG. 1 depicts a block diagram of an example environment that demonstrates various aspects of the present disclosure, and in which some implementations disclosed herein can be implemented.

FIG. 2 depicts an overview of an example method for generating training examples for a machine-learning training dataset.

FIG. 3 depicts a flowchart that illustrates an example method for generating training examples for a machine-learning training dataset.

FIG. 4 depicts a flowchart that illustrates an example method for training a reward model and/or a generative model.

FIG. 5 depicts an example architecture of a computing device, in accordance with various implementations.

### DETAILED DESCRIPTION

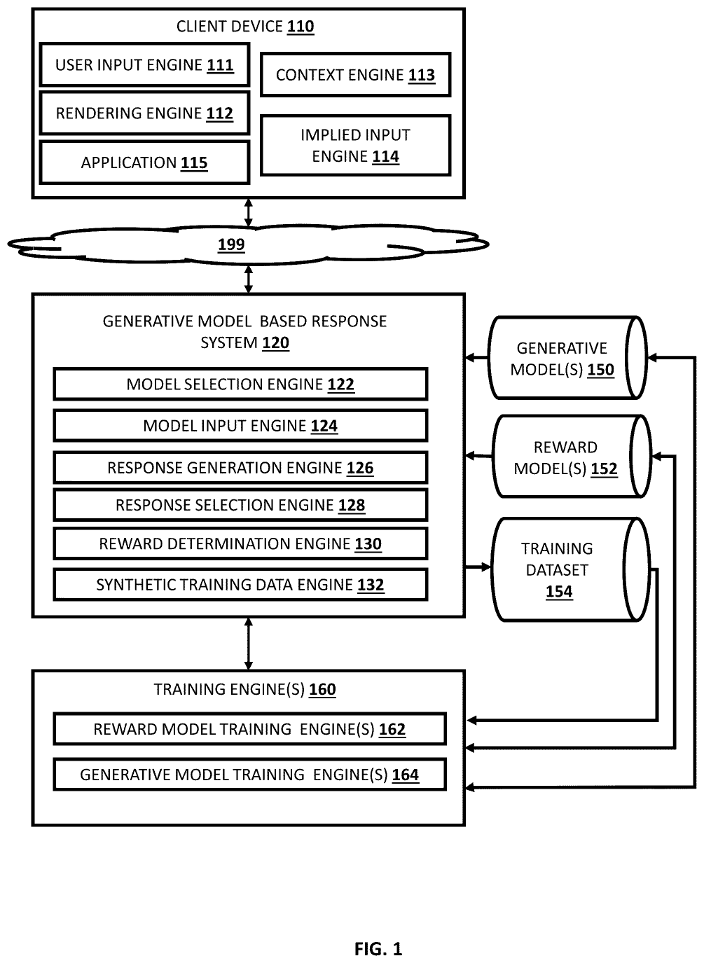

Turning now to FIG. 1, a block diagram of an example environment 100 that demonstrates various aspects of the present disclosure, and in which implementations disclosed herein can be implemented is depicted. The example environment 100 includes a client device 110, a generative model-based response system 120, and a training system 160. Although illustrated separately, in some implementations all or aspects of generative model-based response system 120 and all or aspects of the training system 160 can be implemented as part of a cohesive system.

In some implementations, all or aspects of the generative model-based response system 120 can be implemented locally at the client device 110. In additional or alternative implementations, all or aspects of the generative model-based response system 120 can be implemented remotely from the client device 110 as depicted in FIG. 1 (e.g., at remote server(s)). In those implementations, the client device 110 and the generative model-based response system 120 can be communicatively coupled with each other via one or more networks 199, such as one or more wired or wireless local area networks (“LANs,” including Wi-Fi LANs, mesh networks, Bluetooth, near-field communication, etc.) or wide area networks (“WANs”, including the Internet).

The client device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided.

The client device 110 can execute one or more applications, such as application 115, via which input data can be provided and/or selected, and/or other response(s) to the input data can be rendered (e.g., audibly and/or visually). The application 115 can be an application that is separate from an operating system of the client device 110 (e.g., one installed “on top” of the operating system)—or can alternatively be implemented directly by the operating system of the client device 110. For example, the application 115 can be a web browser installed on top of the operating system, or can be an application that is integrated as part of the operating system functionality. The application 115 can interact with the generative model-based response system 120.

In various implementations, the client device 110 can include a user input engine 111 that is configured to detect user input provided by a user of the client device 110 using one or more user interface input devices. For example, the client device 110 can be equipped with one or more microphones that capture audio data, such as audio data corresponding to spoken utterances of the user or other sounds in an environment of the client device 110. Additionally, or alternatively, the client device 110 can be equipped with one or more vision components that are configured to capture vision data corresponding to images and/or movements (e.g., gestures) detected in a field of view of one or more of the vision components. Additionally, or alternatively, the client device 110 can be equipped with one or more touch sensitive components (e.g., a keyboard and mouse, a stylus, a touch screen, a touch panel, one or more hardware buttons, etc.) that are configured to capture signal(s) corresponding to touch input directed to the client device 110. Some instances of input data described herein can be input data that is formulated based on user input provided by a user of the client device 110 and detected via user input engine 111. For example, a query can be typed via a physical or virtual keyboard, a suggested query that is selected via a touch screen or a mouse, a spoken voice query that is detected via microphone(s) of the client device, or an image query that is based on an image captured by a vision component of the client device or an image stored in a memory of the client device.

In various implementations, the client device 110 can include a rendering engine 112 that is configured to provide content (e.g., generative content) for audible and/or visual presentation to a user of the client device 110 using one or more user interface output devices. For example, the client device 110 can be equipped with one or more speakers that enable content to be provided for audible presentation to the user via the client device 110. Additionally, or alternatively, the client device 110 can be equipped with a display or projector that enables content to be provided for visual presentation to the user via the client device 110.

In various implementations, the client device 110 can include a context engine 113 that is configured to determine a context (e.g., current or recent context) of the client device 110 and/or of a user of the client device 110. In some of those implementations, the context engine 113 can determine a context utilizing current or recent interaction(s) via the client device 110, a location of the client device 110, profile data of a profile of a user of the client device 110 (e.g., an active user when multiple profiles are associated with the client device 110), and/or other data accessible to the context engine 113. For example, the context engine 113 can determine a current context based on a current state of a query session (e.g., considering one or more recent queries of the query session), profile data, and/or a current location of the client device 110. For instance, the context engine 113 can determine a current context of “looking for a healthy lunch restaurant in Louisville, Kentucky” based on a recently issued query, profile data, and a location of the client device 110. As another example, the context engine 113 can determine a current context based on which application is active in the foreground of the client device 110, a current or recent state of the active application, and/or content currently or recently rendered by the active application. A context determined by the context engine 113 can be utilized, for example, in supplementing or rewriting a query that is formulated based on user input, in generating an implied query (e.g., a query formulated independent of user input), and/or in determining to submit an implied query and/or to render result(s) (e.g., an NL based summary) for an implied query.

In various implementations, the client device 110 can include an implied input engine 114 that is configured to: generate an implied query independent of any user input directed to formulating the implied query; to submit an implied query, optionally independent of any user input that requests submission of the implied query; and/or to cause rendering of result(s) for an implied query, optionally independent of any user input that requests rendering of the result(s)). For example, the implied input engine 114 can use current context, from context engine 113, in generating an implied query, determining to submit the implied query, and/or in determining to cause rendering of result(s) for the implied query. For instance, the implied input engine 114 can automatically generate and automatically submit an implied query based on the current context. Further, the implied input engine 114 can automatically push result(s) to the implied query to cause them to be automatically rendered or can automatically push a notification of the result(s), such as a selectable notification that, when selected, causes rendering of the result(s). As another example, the implied input engine 114 can generate an implied query based on profile data (e.g., an implied query related to an interest of a user), submit the query at regular or non-regular intervals, and cause corresponding result(s) for the submission(s) to be automatically provided (or a notification thereof automatically provided).

Further, the client device 110 and/or the generative model-based response system 120 can include one or more memories for storage of data and/or software applications, one or more processors for accessing data and executing the software applications, and/or other components that facilitate communication over one or more of the networks 199. In some implementations, one or more of the software applications can be installed locally at the client device 110, whereas in other implementations one or more of the software applications can be hosted remotely (e.g., by one or more servers) and can be accessible by the client device 110 over one or more of the networks 199.

Although aspects of FIG. 1 are illustrated or described with respect to a single client device having a single user, it should be understood that is for the sake of example and is not meant to be limiting. For example, one or more additional client devices of a user and/or of additional user(s) can also implement the techniques described herein. For instance, the client device 110, the one or more additional client devices, and/or any other computing devices of a user can form an ecosystem of devices that can employ techniques described herein. These additional client devices and/or computing devices may be in communication with the client device 110 (e.g., over the network(s) 199). As another example, a given client device can be utilized by multiple users in a shared setting (e.g., a group of users, a household).

The generative model-based response system 120 is illustrated as including a model selection engine 122, a model input engine 124, a response generation engine 126, a response selection engine 128, a reward generation engine 130, and a synthetic training data engine 132. Some of the engines can be omitted in various implementations. In some implementations, the engines of the generative model are distributed across one or more computing systems.

The model selection engine 122 can, in response to receiving a query or other input, determine which, if any, of multiple generative model(s) 150 (e.g., LLM(s), image generation models, audio generation models and/or other generative model(s)) to utilize in generating response(s) to render responsive to the query/input. For example, the model selection engine 122 can select none, one, or multiple generative model(s) to utilize in generating response(s) to render responsive to a query/input. The model selection engine 122 can optionally utilize one or more classifiers and/or rules (not illustrated).

The model input engine 124 can, in response to receiving a query/input data, generate model input that is to be processed using a generative model in generating a response to the query/input data. As described herein, such content can include query content that is based on the query and/or additional content, such as contextual information. The model input engine can, for example, reformat input data into a suitable form for input into a generative model, e.g., reformat an input NL query as a prompt for an LLM, reformat one or more input images into a tensor for input into an image generation model or the like.

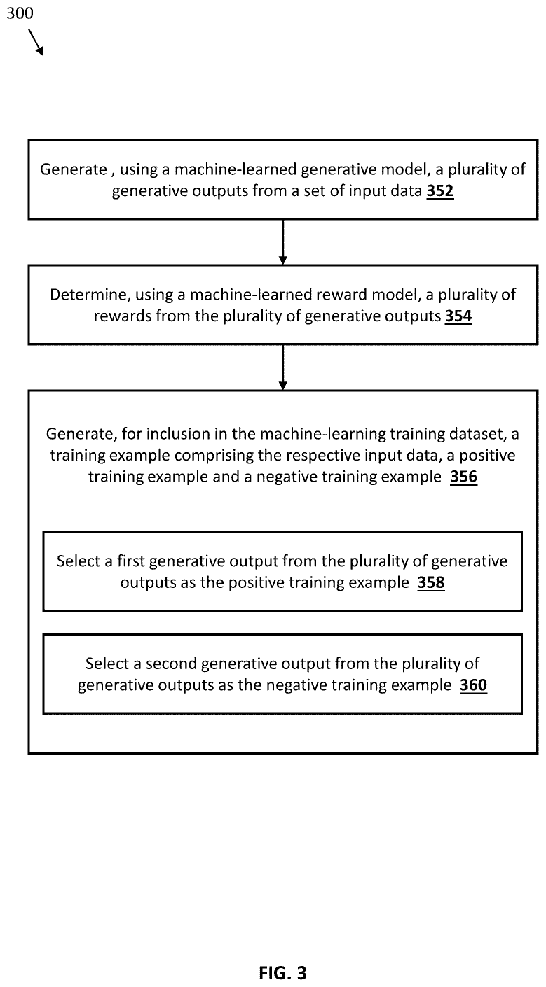

The response generation engine 126 can process input data that is generated by the model input engine 124 using a generative model to generate response/output data. The response generation engine 126 can generate a plurality of candidate responses from the input data/query using one or more generative models 150, e.g., LLMs, image generation models, audio generation models or the like. In various implementations, response generation engine 126 can perform all or aspects of block 352 of FIG. 3.

The response selection engine 128 can select one or more of the candidate responses generated by the response generation engine 126 for presentation to the user, e.g., via the rendering engine 112 and/or application 115 of the client device 110. In some implementations, the response selection engine 128 may utilize one or more reward models 152 to select the one or more of the candidate responses for presentation to the user, e.g., utilize the output of the reward determination engine 128.

The reward determination engine 130 can utilize one or more reward models 152 (also referred to as “preference models”) to determine rewards for the candidate generative outputs generated by the response generation engine 126. The one or more reward models 152 may comprise one or more pointwise reward models, i.e., reward models that take a candidate generative output as input and generate a score for said candidate generative output indicative of how preferred the candidate output is as a response to the input data/query. The one or more reward models 152 may comprise one or more pairwise reward models, i.e., reward models that take a pair of candidate generative outputs as input and generate a score for said pair of candidate generative output indicative of how likely one candidate input of the pair is to be preferred over the other candidate input of the pair as a response to the input data/query. In various implementations, can perform all or aspects of block 354 of FIG. 3.

The synthetic training data engine 132 can generate one or more training examples for inclusion in a training dataset 1154 from the plurality of generative outputs generated by the response generation engine 126 from the input data. A training example comprises a positive training sample, y₊, selected from the plurality of candidate generative outputs, a negative training sample, y₋, selected from the plurality of candidate generative outputs, and their corresponding input data, q, e.g., the set (q, y₊, y₋). The synthetic training data engine 132 utilizes the reward values generated by the reward determination engine 130 to select the positive and negative training examples (collectively referred to as a “preference pair”). In various implementations, the synthetic training data engine 132 can perform all or aspects of blocks 356, 358 and/or 360 of FIG. 3.

The training engine(s) 160 is illustrated as including one or more reward model training engines 162 and one or more generative model training engines 164. Some of the engines can be omitted in various implementations. Further training engines may also be included in the set of external applications 160.

The one or more reward model training engines 162 can utilize labeled/preference training data, e.g., human labeled/preference data or synthetic labeled/preference data, to train and/or evaluate the one or more reward models 152. For example, the one or more reward model training engines 162 can use training data from a training dataset to retrain/fine-tune parameters of one or more of the reward models 152. Alternatively or additionally, the one or more reward model training engines 162 can use evaluation data from an evaluation dataset to evaluate the performance of one or more of the reward models 152. In some implementations, the one or more reward model training engines 162 can perform a model distillation process using synthetic labeled/preference data generated by the synthetic training data engine 132 to distill a base reward model (i.e., a teacher reward model) into a student reward model that has a different model structure to the base reward model, e.g., fewer parameters, a fewer number of layers, simpler layers, or the like.

The one or more generative model training engines 164 can utilize training data and/or one or more reward models to train and/or evaluate the one or more generative models 150. For example, the one or more generative model training engines 164 can use training data from a training dataset to retrain/fine-tune parameters of one or more of the generative models 150, for example to increase model alignment. The one or more generative model training engines 164 may utilize reinforcement learning techniques to train the one or more generative models 150, using one or more reward models 152 to provide a reward for the reinforcement learning.

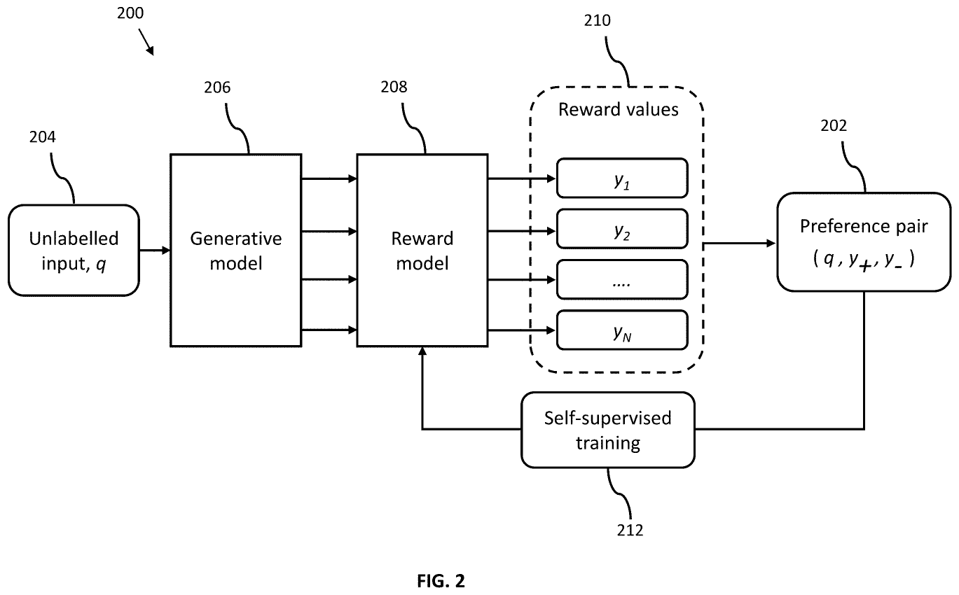

Turning now to FIG. 2, FIG. 2 illustrates an overview of an example method 200 for generating training examples 202 for a machine-learning training dataset. Each training example comprises a respective input 204, q, for a generative model 206, a positive example, y₊, of an output from the generative model (also referred to as a “positive training example”) and a negative example, y₋, of an output from the generative model (also referred to as a “positive training example”), i.e., the training example comprises an ordered pair of generative outputs, where the positive example is preferred over the negative example according to a reward model 208. The training example 202 is also referred to herein as a “preference pair” for the input, q.

A generative model 206, π, receives input data 204, q, as input, and processes it to generate a plurality of candidate generative outputs, e.g., N outputs y₁, y₂, . . . , y_{N}. A reward model 208, P, processes the plurality of candidate generative outputs to determine a plurality of reward scores 210, each reward score corresponding to a respective one or more of the candidate generative outputs. Based on the reward scores 210, a pair of generative outputs are selected for inclusion in the training example 202, where a first generative output of the pair, y₊, is indicated by the reward scores 210 as being preferred over a second generative output of the pair, y₋. The resulting training example 202 can be included in a training dataset (not shown) that may be used to update the reward model 208 and/or the generative model 206 using self-supervised learning 212, e.g., to train/finetune parameters of the reward model 208 and/or the generative model 206. The method 200 is repeated for a plurality of unlabeled inputs, {q}, to generate a set of synthetic training data.

The generative model 206 may, in some implementations, be a neural network model. For example, the generative model 206 may comprise one or more of: a convolutional neural network; a variational autoencoder; a recurrent neural network (RNN), such as a long short-term memory (LSTM) network; a transformer-based network; or the like. The generative model 206 may be a generative model trained using generative-adversarial techniques, such as a conditional GAN (cGAN). The generative model 206 may be a stable diffusion model. Many other examples are possible.

The generative model 206, in some examples, generates a probability distribution over a set of outputs, e.g., a probability distribution over a set of pixel values, phonemes and/or tokens. The probability distribution may be a conditional probability distribution. The probability distribution can be sampled to generate each candidate generative output in the plurality of candidate outputs.

In some implementations, the generative model 206 is an image generation model configured to generate images from a set of input data 204. The input data 204 for such image generation models may comprise a natural language description of a desired output image, e.g., “draw me a picture of a cat”. The generative model 206 may generate a plurality of images conditioned on the input natural language description, e.g., a plurality of images of a cat in this example. Alternatively or additionally, the input data 204 may comprise one or more images that are used to condition the generation of the output images. In some implementations, the input data 204 may comprise a content image indicating a desired content for a generated image and a style image indicating a desired style for a generated image. For example, the content image may be an image of a cat, and the style image may be an image in an impressionistic style, which guide the generative model to generate images of cats in an impressionistic style.

In some implementations, the generative model 206 is an audio generative model configured to generate audio samples from a set of input data 204. The input data 204 may comprise text data, e.g., text data representing a description of a desired audio output, and/or content of the desired output. The input data 204 may comprise audio data, e.g., audio data representing a desired audio output style and/or content. The generative model 206 may generate a plurality of audio samples conditioned on the input data 204.

In some implementations, the generative model 206 is a large language model configured to generate a sequence of text tokens from a set of input data 204. The input data 204 comprises a natural language prompt, e.g., a sequence of text tokens. The prompt may be a query or request for the LLM to provide some information, or to perform a function. For example, the input prompt may comprise the text “Can you summarize the plot to the play Hamlet”. Based on this prompt the LLM generates a plurality of textual summaries of the play Hamlet.

In some implementations, the generative model is a multi-modal generative model configured to generate output data in a plurality of modalities and/or receive input data in a plurality of modalities.

The reward model 208 may be pre-trained based on a reinforcement-learning from human feedback (RLHF) framework. In such a framework, the spaces of generative model inputs 204 and outputs are denoted by X and Y respectively, with π: X→Y denoting the action of the generative model 206. To update the generative model 206, human feedback is typically collected in the form of pairwise preferences between two candidate responses, (y₊, y₋) ∈ Y² to a given query, q ∈ X. The preference of y₊ over y₋ is denoted y₊>y₋. A human labeled dataset is given by D_{HF}={(q, y₊, y₋), y₊>y₋}. A base reward model 208 may be trained on the human labeled dataset to predict reward data for outputs of the generative model 206. The reward model 208 may then be leveraged to improve generation quality of the generative model 206 through reinforcement learning, e.g., by aligning the generative model 206 to the labeled data.

In some examples, the base reward model 208 may be trained on a labeled dataset provided by an organization/particular user to tailor the base reward model 208 to the requirements of that organization/particular user. However, it is difficult for an organization or an individual user to collect large amounts of training data, which can result in inaccuracies/poor alignment of the reward model 208 trained on this data. The method 200 provides a means of augmenting such training datasets to improve model alignment of the reward model 208 and generative model 206, despite limited human labeled data being available.

Assuming access to a dataset of unlabeled input data, D_{U}={q:q ∈ X}, the method 200 provides a sampling strategy f_{±}: X→Y² that outputs for an input q ∈ X a pair of generative outputs f_{±}(q)=(y₊, y₋) such that the output y₊ is “preferred” (e.g., ranked more highly) over the response y₋. This allows a dataset of synthetic labeled data to be generated by labeling D_{U} with pseudo labels D_{L}, ={(q, f_{±}(q))}. The reward model 208, or a further reward model, can be trained on D_{L},. This reward model can be used to train the generative model using reinforcement learning.

In some examples, the reward model 208 takes as input a single generative output from the generative model 206 and outputs a score (i.e., a reward) indicative of how aligned the output is with the human labeled data that the base reward model 208 has been trained on. Such a reward model 206 may be referred to as a “pointwise reward model”, and denoted r₀, where θ denotes parameters of the reward model 208, and correspond to a map r:X×Y→R. In some examples, the reward model 208 is based on the Bradley-Terry model under which pairwise preferences between generative outputs are assumed to be determined from the pointwise model, r, using:

$${P}_{θ} ( q ) = \frac{exp exp ( r ( q , {y}_{+} ) )}{exp exp ( r ( q , {y}_{+} ) ) + exp exp ( r ( q , {y}_{-} ) )} .$$

In some examples, the reward model 208 may take as input a pair of generative outputs from the generative model 206 and output data (i.e., a reward) indicative of a probability that one of the generative outputs of the pair is preferred over the other given the input to the generative network. For example, the output of the reward model 208 may be denoted by P_{θ}(yᵢ>yᵢ|q), where θ represents the parameters of the reward model 208, P, yᵢ ∈ Y is a first generative output of the pair of generative outputs, yⱼ ∈ Y is a second generative output of the pair of generative outputs, and q is the input 204 to the generative model 206. Such a reward model 208 may be referred to as a “pairwise reward model”.

The base reward model 208 may be estimated from the human labeled dataset prior to use in generating the synthetic dataset. For example, for reward models based on the Bradley-Terry model, parameters of the reward model may be estimated from the human labeled dataset using a maximum likelihood method applied to a loss function. For example, the maximum likelihood of the following loss function can be estimated to determine the parameters of the reward model:

$${E}_{( q , {y}_{+} , {y}_{-} ) ∼ {D}_{HF}} [ log log ( σ ( r ( q , {y}_{+} ) - r ( q , {y}_{-} ) ) ) ]$$

where σ is the sigmoid function.

To generate synthetic preference pairs 202, the reward model 208 is used to assess candidate outputs of the generative model 206 to select a pair of generative outputs in which one element of the pair is “preferred” over the other, i.e., one element of the pair is a good training example, and one is a bad training example. For example, given a set of pairwise preferences, P_{θ}(yᵢ→yⱼ|q), a preference pair that maximizes the probability that yᵢ is preferred over yⱼ is selected as the synthetic training example 202, i.e.,

$${P}_{θ} ( {y}_{+} ≻ {y}_{-} \vert q ) .$$

In some implementations, this equation can be solved by taking the highest ranked and lowest ranked generative outputs, as indicated by a pointwise reward model, r. In such examples, the candidate generative outputs may be ranked based on their respective rewards, and the top ranked candidate generative output selected as the positive training example, y₊. The lowest ranked generative output may be selected as the negative training example, y₋. Such a pair essentially takes the best of N generated outputs and worst of the N generated outputs and may thus be referred to as a “West-of-N pair”.

In examples where the reward model is a pairwise reward model, a two-way tournament can be performed to select the preference pair for the training example 202.

In some implementations, the candidate generative outputs are filtered prior to and/or subsequent to selecting the training example 202. This can improve the quality of the generated preference pairs.

The filtering may comprise determining a model confidence value in labeling a preference, e.g., the value P_{θ}(yᵢ>yⱼ|q) for pair (yᵢ, yⱼ). The confidence values for pairs are compared to a threshold confidence value, e.g., to see if the confidence value of a pair exceeds the threshold confidence value. Preference pairs that satisfy this threshold confidence value are retained (i.e., preference pairs that fail to satisfy this threshold confidence value are dropped).

Alternatively or additionally, the filtering may comprise determining a likelihood value for each candidate generative output that indicates how likely the candidate generative output is given the input 204, q, e.g., π(y₊|q), π(y₋|q). The likelihood of each candidate generative output is compared to a threshold likelihood value, e.g., a minimum likelihood value. Generative outputs that fail to satisfy the threshold likelihood (e.g., are below the minimum likelihood value) are not included in the preference pairs. Alternatively, preference pairs that contain a generative output that fails to satisfy the threshold likelihood are dropped. This likelihood filtering can ensure that the responses being compared remain in-distribution, i.e., that extremely unlikely positive or negative responses are not included in the training data.

In some examples, once the synthetic training dataset D_{L}, ={(q, f_{±}(q))} has been generated, it can be combined with human labeled data to generate a mixed training dataset. In some alternative examples, the synthetic training dataset D_{L}, is used as a training dataset without combining with any further training data.

The resulting training dataset comprising the selected training examples can be used to update the reward model 208 and/or the generative model 206. For example, the reward model 208 can be updated/fine-tuned using a self-supervision approach. The same approach used to train the base reward model 208 may be used to train the updated reward model, with the synthetic training dataset being used for the training instead of or in addition to the human labeled data.

In some examples, the training dataset can be used to distill a student reward model from the reward model 208. The student reward model, in some examples, has an architecture that is specialized for execution on specific sets of hardware/devices. For example, the student reward model may have an architecture that has a memory footprint below a threshold value in order to be able to be executed on hardware with a constrained memory space. Alternatively or additionally, the student reward model may have an architecture that allows parts of the student reward model to be implemented in parallel to take advantage of parallel processing capabilities of a particular set of hardware.

The updated reward model 208 can be used in a reinforcement learning process to update the generative model 206. This update process can steer the parameterization of the generative model 206 towards outputs with high rewards. Example of reinforcement learning processes using a reward model are described in “Learning to summarize with human feedback” (N. Stiennon et al., Advances in Neural Information Processing Systems, 33:3008-3021, 2020) and “Fine-tuning language models from human preferences” (D. Ziegler et al., arXiv: 1909.08593. 2019), the contents of both of which are incorporated herein by reference.

In some implementations, the generative model 206 may be updated/fine-tuned based on applying an optimization routine to a reinforcement learning objective function. For example, an optimization routine may be applied to the following objective over a set of prompts, D={x:x ∈ X}:

$${E}_{x ∼ D , y ∼ π} {r}_{θ} ( x , y ) - β {D}_{KL} ( π ( y \vert x ) \vert \vert {π}_{0} ( y \vert x ) ) ,$$

where D_{KL} is the Kullback-Leibler divergence, π₀ is a reference policy (e.g., a supervised fine-tuning checkpoint) and β is a hyperparameter controlling the strength of the regularization. The latter regularization term in the objective function ensures that the learned policy does not deviate far from the reference policy.

In some implementations, the method 200 corresponds to the following algorithm, where the reward model is referred to as a “preference model” and the human labeled dataset is referred to as a “base preference dataset”:

Algorithm 1 West-of-N Preference Model Training.

```
Input: Language model π. Base preference dataset [symbol]   _{L} [symbol]
Unlabeled queries dataset [symbol]   _{U} [symbol]
  Train base preference model P_{θ} on [symbol]    _{L} [symbol]
  Initialize [symbol]   _{L} [symbol]  = ∅
  for x ∈ [symbol]   _{U} do
    Sample N responses: C = {yᵢ : yᵢ ~ π(x)}ᵢ₌₁ [symbol] ^{N}
    Construct West-of-N preference pair:
      (y₊,y₋) = arg max P_{θ} (yᵢ [symbol]  yⱼ|x) [symbol]
        ∈^{C}
    Optional: Filler based on P_{θ}(y₊ [symbol]  y₋|x) or π(y_{±}|x).
    Update [symbol]   _{L} [symbol]  = [symbol]    _{L} [symbol]  {(x, y₊,y₋)}.
  end for
  Train preference model on [symbol]   _{L} ∪ [symbol]    _{L} [symbol] . [symbol]
indicates data missing or illegible when filed
```

Turning now to FIG. 3 a flowchart is depicted that illustrates an example method 300 for generating a set of synthetic labeled/preference data. The method 300 corresponds to the method 200 described in relation to FIG. 2. For convenience, the operations of the method 300 are described with reference to a system that performs the operations. This system of the method 300 includes one or more processors, memory, and/or other component(s) of computing device(s). Moreover, while operations of the method 300 are shown in a particular order, this is not meant to be limiting. One or more operations may be reordered, omitted, and/or added.

At block 352, the system generates a plurality of generative outputs, {y₁, y₂ . . . , Y_{N}:yᵢ ∈ Y}, from a set of input data, q, using a machine-learned generative model. The set of input data may originate from a set of unlabeled training inputs, D_{U}={q:q ∈ X}.

In some implementations the machine-learned generative model is an image generation model configured to generate image data from a set of input data. In such implementations, the plurality of generative outputs comprises a plurality of images. The respective input data comprises, for example: one or more input images, e.g., a content image indicating a desired content of a generated image and a style image indicating a desired style of the generated image; an input natural language description of a desired output; and/or a noise vector.

In some implementations the machine-learned generative model is a large language model. Each respective set of input data comprises an input prompt, i.e., a natural language input, such a query. The input prompt may, in some examples, be received from a user in the form of typed text. Alternatively or additionally, the input prompt may, in some examples, be received from a user in the form of a spoken utterance, that may be converted to text using a speech-to-text process. The plurality of generative outputs comprises a plurality of text sequences, e.g., a natural language text sequence that is responsive to the input query.

Generating, using the machine-learned generative model, the plurality of generative outputs from a respective set of input data comprises, in some implementations, generating one or more distributions over a set of potential generative outputs. Each generative output in the plurality of generative outputs may be generated by sampling from this distribution, e.g., each generative output may correspond to a different decoding of a probability distribution generated using the machine-learned generative model.

At block 354, the system determines a plurality of rewards from the plurality of generative outputs using a machine-learned reward model. Each reward is associated with one or more of the generative outputs in the plurality of generative outputs. The reward model may be a base reward model that has been trained on a set of human labeled data to generate the rewards.

In some implementations, the reward model is a pointwise reward model in which each reward is associated with a single generative output, i.e., the reward model processes each generative output individually to generate a respective reward for that generative output. A reward may be a numerical value indicative of a predicted preference score for the generative output. In some examples, a higher score indicates a higher predicted preference than a lower score. In other examples, a lower score indicates a higher predicted preference than a higher score. Based on the rewards for each generative output, a ranking of the plurality of generative outputs can be determined, i.e., by ordering the generative outputs in ascending/descending order of their respective rewards. Alternatively, pairwise preference scores between the plurality of outputs may be determined based on the rewards, e.g., using the Bradley-Terry model.

In some implementations, the reward model is a pairwise reward model in which each reward is associated with a pair of generative outputs, e.g., the reward model processes an ordered pair of generative outputs (e.g., a first generative output and a second generative output) to generate a respective reward for that pair. The reward may be a numerical value indicative of a probability that the first generative output, y₁, of the pair is preferred over the second generative output, y₂, of the pair, e.g., P(y₁>y₂|q).

At block 356, the system generates a training example for inclusion in the machine-learning training dataset. A training example comprises a positive training example, a negative training and the respective input data from which they were generated, e.g., the set {q, y₊, y₋}. The reward associated with the positive training example and the reward associated with the negative training example indicate that the positive training example is preferred over the negative training example.

Generating a training example for inclusion in the machine-learning training dataset comprises, at block 358, selecting a first generative output from the plurality of generative outputs as the positive training example, y₊, based on a reward associated with the first generative output. Generating a training example for inclusion in the machine-learning training dataset further comprises, at block 360, selecting a second generative output from the plurality of generative outputs as the negative training example, y₋, based on a reward associated with the second generative output.

In some implementations, generating a training example for inclusion in the machine-learning training dataset comprises ranking the plurality of generative outputs based on their respective reward values, e.g., the pointwise reward values associated with the plurality of generative outputs. A higher ranking indicates that an output is more aligned with the human labeled dataset used to train the reward model than a lower ranking. In such examples, the first generative output is ranked higher than the second generative output. The highest ranked and lowest ranked generative outputs may be selected for inclusion in the training example as the positive and negative training examples respectively.

In implementation where the reward model is a pairwise reward model, generating a training example for inclusion in the machine-learning training dataset may comprise performing a two-way tournament between the pairs to identify a pair for inclusion in the training example.

Blocks 352 to 360 can be iterated over a plurality of sets of input data to generate a synthetic training dataset.

In some implementations the method further comprises filtering the training examples. The filtering may include removing training examples in which a probability that the positive training example is preferred over the negative training example is below a threshold probability. For example, the system may determine a confidence value that the first generative output is preferred over the second generative output, e.g., using the value P(y₁>y₂|q). The system compares the confidence value to a threshold confidence value. If the system determines that the confidence value does not satisfy the threshold confidence value, e.g., is below the threshold confidence value, the system discards the training example from the machine-learning training dataset. This can remove training examples where the ordering of the positive training example and the negative training example is uncertain, e.g., when they are similarly preferred.

The filtering may include removing training examples in which one or more of the positive training example and/or negative training example has a low likelihood of occurring, e.g., is sampled from an extreme of the distribution generated by the generative model. This can remove unlikely or unrealistically good/bad responses from the generative outputs, resulting in more realistic synthetic training data. For example, a system may determine a first likelihood value for the first generative output of the training example and/or second likelihood value for the second generative output, e.g., based on a probability distribution generated by the generative model. The system compares the first likelihood value and/or second likelihood value to a threshold likelihood value. If the system determines that one or more of the first likelihood value and/or second likelihood value do not satisfy the threshold, e.g., one or more of the likelihood values are below the threshold likelihood value, then the system discards the training example.

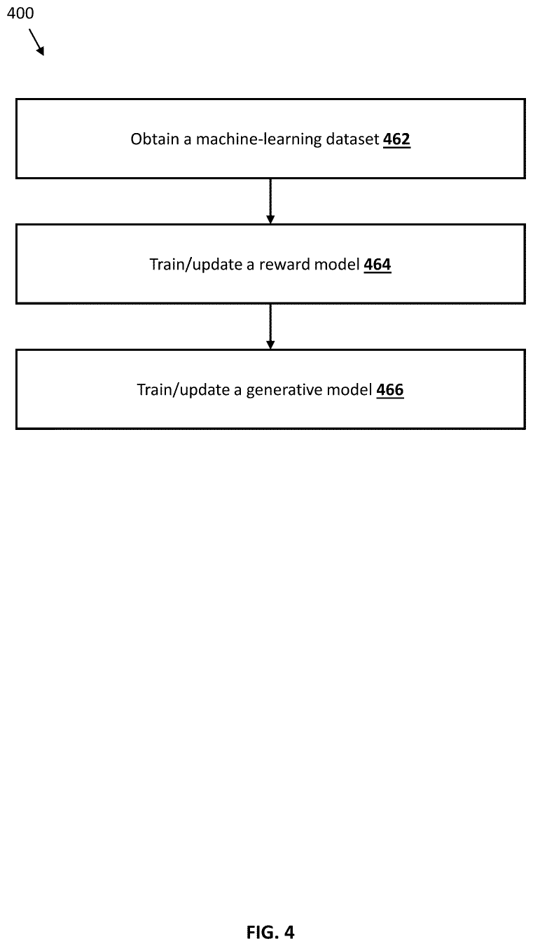

Turning now to FIG. 4, a flowchart is depicted that illustrates an example method 400 for training a reward model and/or a generative model. For convenience, the operations of the method 400 are described with reference to a system that performs the operations. This system of the method 400 includes one or more processors, memory, and/or other component(s) of computing device(s). Moreover, while operations of the method 400 are shown in a particular order, this is not meant to be limiting. One or more operations may be reordered, omitted, and/or added.

At block 462, the system obtains a machine-learning dataset. The machine-learning dataset comprises synthetic training data generated using any one or more of the methods described herein.

At block 464, the system trains a reward model using the machine-learning dataset.

For example, the system may update/fine-tune a base reward model (i.e. the reward model used to generate the synthetic training data) using the machine-learning dataset. This can result in a reward model that is more closely aligned to the human labeled dataset.

Alternatively or additionally, the system may train a student reward model using the machine-learning dataset, i.e., in effect use the base reward model as a teacher model in a model distillation process. The student reward model may have a different architecture to the base reward model. For example, the student reward model can have an architecture that is adapted to specific hardware constraints, such as restricted memory spaces. The student reward model may, for example, have a memory footprint below a threshold memory size that is available for execution of the model on a specific set of devices/hardware, e.g., mobile computing devices.

At block 466, the system trains/updates a generative model using the reward model trained at block 464. The generative model may be trained using reinforcement learning techniques, utilizing the output of the reward model as a reward signal. This can result in a generative model that is more closely aligned to the human labeled dataset. The reinforcement learning model may be the reinforcement learning model used to generate the synthetic training dataset, e.g., the reward model trained at block 464 is used to fine-tune the generative model.

Alternatively or additionally, the system may train a student generative model using the reward model trained at block 464, i.e., indirectly using the original generative model as a teacher model via the reward model in a model distillation process. The student generative model may have a different architecture to the original generative model. For example, the student generative model can have an architecture that is adapted to specific hardware constraints, such as restricted memory spaces. The student generative model may, for example, have a memory footprint below a threshold memory size that is available for execution of the model on a specific set of devices/hardware, e.g., mobile computing devices.

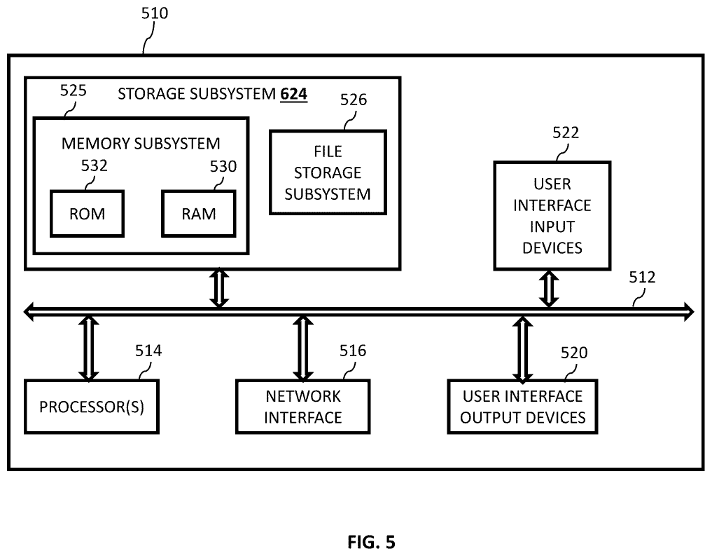

Turning now to FIG. 5, a block diagram of an example computing device 510 that may optionally be utilized to perform one or more aspects of techniques described herein is depicted. In some implementations, one or more of a client device, cloud-based automated assistant component(s), and/or other component(s) may comprise one or more components of the example computing device 510.

Computing device 510 typically includes at least one processor 514 which communicates with a number of peripheral devices via bus subsystem 512. These peripheral devices may include a storage subsystem 524, including, for example, a memory subsystem 525 and a file storage subsystem 526, user interface output devices 520, user interface input devices 522, and a network interface subsystem 516. The input and output devices allow user interaction with computing device 510. Network interface subsystem 516 provides an interface to outside networks and is coupled to corresponding interface devices in other computing devices.

User interface input devices 522 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 510 or onto a communication network.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 510 to the user or to another machine or computing device.

Storage subsystem 524 stores programming and data constructs that provide the functionality of some, or all, of the modules described herein. For example, the storage subsystem 524 may include the logic to perform selected aspects of the methods disclosed herein, as well as to implement various components depicted in FIG. 1.

These software modules are generally executed by processor 514 alone or in combination with other processors. Memory 525 used in the storage subsystem 524 can include a number of memories including a main random-access memory (RAM) 530 for storage of instructions and data during program execution and a read only memory (ROM) 532 in which fixed instructions are stored. A file storage subsystem 526 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 526 in the storage subsystem 524, or in other machines accessible by the processor(s) 514.

Bus subsystem 512 provides a mechanism for letting the various components and subsystems of computing device 510 communicate with each other as intended. Although bus subsystem 512 is shown schematically as a single bus, alternative implementations of the bus subsystem 512 may use multiple busses.

Computing device 510 can be of varying types including a workstation, server, computing cluster, blade server, server farm, or any other data processing system or computing device. Due to the ever-changing nature of computers and networks, the description of computing device 510 depicted in FIG. 5 is intended only as a specific example for purposes of illustrating some implementations. Many other configurations of computing device 510 are possible having more or fewer components than the computing device depicted in FIG. 5.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a computer implemented method of generating training examples for a machine-learning training dataset is provided and includes, for each of a plurality of sets of input data: generating, using a machine-learned generative model, a plurality of generative outputs from a set of input data; determining, using a machine-learned reward model, a plurality of rewards from the plurality of generative outputs, each reward associated with one or more of the plurality of generative outputs; generating, for inclusion in the machine-learning training dataset, a training example comprising the respective input data, a positive training example and a negative training example, comprising: selecting, from the plurality of generative outputs, a first generative output as the positive training example in the machine-learning training dataset based on a reward associated with the first generative output; and selecting, from the plurality of generative outputs, a second generative output as the negative training example in the machine-learning training dataset based on a reward associated with the second generative output, where the reward associated with the first generative output and the reward associated with the second generative output indicate that the first generative output is preferred over the second generative output.

These and other implementations disclosed herein can include one or more of the following features.

In some implementations, the machine-learned generative model is an image generation model, and the plurality of generative outputs comprises a plurality of images.

In some implementations, the machine-learned generative model is a large language model, each respective set of input data comprises an input prompt, and the plurality of generative outputs comprises a plurality of text sequences.

In some implementations, generating, using the machine-learned generative model, the plurality of generative outputs from a respective set of input data comprises: generating a distribution over a set of potential generative outputs; and sampling the plurality of generative outputs from the distribution.

In some implementations, the method further includes, for each of one or more training examples: determining a confidence value that the first generative output is preferred over the second generative output; determining that the confidence value does not satisfy a threshold confidence value; and in response to determining that the confidence value does not satisfy the threshold confidence value, discarding the training example from the machine-learning training dataset.

In some implementations, the method further includes, for each of one or more training examples: determining a first likelihood value for that the first generative output of the training example and/or second likelihood value for the second generative output; determining that the first likelihood value and/or second likelihood value does not satisfy a threshold likelihood value; and in response to determining that the first likelihood value and/or second likelihood value does not satisfy the threshold likelihood value, discarding the training example from the machine-learning training dataset.

In some implementations, the reward model is a pointwise reward model and determining, using the machine-learned reward model, the plurality of rewards from the plurality of generative outputs comprises: determining, using the reward model, a respective reward for each of the plurality of generative outputs; and generating, based on the rewards, a ranking of the plurality of generative outputs, where the first generative output is ranked higher in the ranking than the second generative output. In some of those implementations, the first generative output is a highest ranked generative output from the plurality of generative outputs and/or the second generative output is a lowest ranked generative output from the plurality of generative outputs.

In some implementations, the reward model is a pairwise reward model and determining, using the machine-learned reward model, the plurality of rewards from the plurality of generative outputs comprises: determining a respective reward for each of a plurality of pairs of generative outputs, where the respective reward for a pair of generative outputs indicates a probability that a first generative output of the pair of generative outputs is preferred over a second generative output of the pair. In some of those implementations, the first generative output corresponds to a first generative output of a pair of generative outputs with the highest reward and the second generative output corresponds to a second generative output of the pair of generative outputs with the highest reward. In some other of those implementations, generating a training example comprises performing a two-way tournament between the plurality of pairs of generative outputs to determine the pair of generative outputs with the highest reward.

In some of those implementations, the method further includes combining the training examples with human labeled training examples to generate the machine-learning training dataset.

In some of those implementations, one or more of the plurality of sets of input data comprises a multimodal input comprising two or more of: one or more images; a text sequence; one or more audio samples; and/or one or more videos.

In some implementations, the method further includes training the reward model or a further reward model based on a machine-learning training dataset comprising training examples generated using the method of any preceding implementation. In some of those implementations, the method further includes training a generative machine-learning model using the reward model.

In some of those implementations, the method further includes distilling a student reward model from a machine-learned reward model, including training the student reward model based on the machine-learning training dataset. In some of those implementations, the student reward model has a memory footprint below a threshold memory usage.

In some implementations, a system including one or more hardware processors and a memory is provided, the memory storing computer readable instructions that, when executed by the one or more processors, causes the system to perform a method according to any implementations disclosed herein.

In some implementations, a transitory or a non-transitory computer readable medium is provided that includes computer-readable instructions that, when executed by hardware processor(s), cause the processor(s) to perform the method according to any implementations disclosed herein.

What is claimed is:

1. A method implemented by one or more processors, the method comprising:
for each of a plurality of sets of input data:
generating, using a machine-learned generative model, a plurality of generative outputs from a set of input data;
determining, using a machine-learned reward model, a plurality of rewards from the plurality of generative outputs, each reward associated with one or more of the plurality of generative outputs;
generating, for inclusion in a machine-learning training dataset, a training example comprising the respective input data, a positive training example and a negative training example, comprising:
selecting, from the plurality of generative outputs, a first generative output as the positive training example in the machine-learning training dataset based on a reward associated with the first generative output; and
selecting, from the plurality of generative outputs, a second generative output as the negative training example in the machine-learning training dataset based on a reward associated with the second generative output,
wherein the reward associated with the first generative output and the reward associated with the second generative output indicate that the first generative output is preferred over the second generative output.

2. The method of claim 1, wherein the machine-learned generative model is an image generation model, and wherein the plurality of generative outputs comprises a plurality of images.

3. The method of claim 1, wherein the machine-learned generative model is a large language model, wherein each respective set of input data comprises an input prompt, and wherein the plurality of generative outputs comprises a plurality of text sequences.

4. The method of claim 1, wherein generating, using the machine-learned generative model, the plurality of generative outputs from a respective set of input data comprises:
generating a distribution over a set of potential generative outputs; and
sampling the plurality of generative outputs from the distribution.

5. The method of claim 1, further comprising:
for each of one or more training examples:
determining a confidence value that the first generative output is preferred over the second generative output;
determining that the confidence value does not satisfy a threshold confidence value; and
in response to determining that the confidence value does not satisfy the threshold confidence value, discarding the training example from the machine-learning training dataset.

6. The method of claim 1, further comprising:
for each of one or more training examples:
determining a first likelihood value for that the first generative output of the training example and/or second likelihood value for the second generative output;
determining that the first likelihood value and/or second likelihood value does not satisfy a threshold likelihood value; and
in response to determining that the first likelihood value and/or second likelihood value does not satisfy the threshold likelihood value, discarding the training example from the machine-learning training dataset.

7. The method of claim 1, wherein the reward model is a pointwise reward model and wherein determining, using the machine-learned reward model, the plurality of rewards from the plurality of generative outputs comprises:
determining, using the reward model, a respective reward for each of the plurality of generative outputs; and
generating, based on the rewards, a ranking of the plurality of generative outputs,
wherein the first generative output is ranked higher in the ranking than the second generative output.

8. The method of claim 7, wherein the first generative output is a highest ranked generative output from the plurality of generative outputs.

9. The method of claim 8, wherein the second generative output is a lowest ranked generative output from the plurality of generative outputs.

10. The method of claim 1, wherein the reward model is a pairwise reward model and wherein determining, using the machine-learned reward model, the plurality of rewards from the plurality of generative outputs comprises:
determining a respective reward for each of a plurality of pairs of generative outputs, wherein the respective reward for a pair of generative outputs indicates a probability that a first generative output of the pair of generative outputs is preferred over a second generative output of the pair.

11. The method of claim 10, wherein:
the first generative output corresponds to a first generative output of a pair of generative outputs with the highest reward; and
the second generative output corresponds to a second generative output of the pair of generative outputs with the highest reward.

12. The method claim 10, wherein generating a training example comprises performing a two-way tournament between the plurality of pairs of generative outputs to determine the pair of generative outputs with the highest reward.

13. The method of claim 1, further comprising:
combining the training examples with human labeled training examples to generate the machine-learning training dataset.

14. The method of claim 1, wherein one or more of the plurality of sets of input data comprises a multimodal input comprising two or more of: one or more images; a text sequence; one or more audio samples; and/or one or more videos.

15. The method of claim 1, further comprising:
training the reward model or a further reward model based on the machine-learning training dataset.

16. The method of claim 15, further comprising training a generative machine-learning model using the reward model.

17. The method of claim 1, further comprising:
distilling a student reward model from the machine-learned reward model, the distilling comprising:
training the student reward model based on the machine-learning training dataset.

18. The method of claim 17, wherein the student reward model has a memory footprint below a threshold memory usage.

19. A system comprising:
one or more processors;
memory storing computer readable instructions that, when executed by the one or more processors, causes the system to:
generate a machine-learning training dataset; and
train a reward model, or a further reward model, based on the machine-learning training dataset;
wherein in generating the machine-learning training dataset one or more of the processors are to:
for each of a plurality of sets of input data:
generate, using a machine-learned generative model, a plurality of generative outputs from a set of input data;
determine, using the reward model, a plurality of rewards from the plurality of generative outputs, each reward associated with one or more of the plurality of generative outputs;
generate, for inclusion in the machine-learning training dataset, a training example comprising the respective input data, a positive training example and a negative training example, wherein in generating the training example one or more of the processors are to:
select, from the plurality of generative outputs, a first generative output as the positive training example in the machine-learning training dataset based on a reward associated with the first generative output; and
select, from the plurality of generative outputs, a second generative output as the negative training example in the machine-learning training dataset based on a reward associated with the second generative output,
wherein the reward associated with the first generative output and the reward associated with the second generative output indicate that the first generative output is preferred over the second generative output.
